(19) United States
(12) Patent Application Publication
(10) Pub. No.: US 2013/0179226 A1
(43) Pub. Date: Jul. 11, 2013

(54) AUTOMATED TASK PRICING IN CROWDSOURCING MARKETPLACES

(71) Applicants: Samuel S. Adams, Rutherfordton, NC (US); Rajarshi Das, Armonk, NY (US); Maja Vukovic, New York, NY (US)

(72) Inventors: Samuel S. Adams, Rutherfordton, NC (US); Rajarshi Das, Armonk, NY (US); Maja Vukovic, New York, NY (US)

(73) Assignee: INTERNATIONAL BUSINESS MACHINES CORPORATION, Armonk, NY (US)

(21) Appl. No.: 13/346,000

(22) Filed: Jan. 9, 2012

(51) Int. Cl. G06Q 30/02

(52) U.S. Cl. 705/7.35

(57) ABSTRACT

Illustrative embodiments disclose pricing tasks by receiving a request comprising a task and a description of the task and then identifying the type of task based on the description. A pricing module retrieves a condition in a marketplace associated with the type and selects a strategy for pricing based on a rule for the type. The module then generates a price for the task using the strategy, and it adjusts the price based on the condition.

### BACKGROUND

1. Field:

The disclosure relates generally to pricing a task to submit to a worker pool and more specifically to automated pricing a task to submit to a crowdsourcing marketplace.

2. Description of the Related Art:

Many businesses increasingly use crowdsourcing to harvest information and garner contributions from workers scattered across networks on the web. Software development, knowledge discovery, graphics design, solutions to critical business problems, and other collaborative endeavors lend themselves to crowdsourcing. Marketplaces are gradually forming integrated crowdsourcing systems and networks with bidding platforms to bring task requestors and providers, i.e., workers, together.

There are few mechanisms in place to efficiently submit and price task for crowdsourcing. No pricing systems exist for automatically and systematically setting a price for tasks to broadcast to a target crowd. In general, task requesters manually estimate a market price for a task, and the task's complexity and nature of the work guide subjective pricing decisions. Requestors can search similar tasks and estimate a price that would bring an expected result from workers. Such estimates ignore current market conditions. Furthermore, requestors themselves often pay a fee to the marketplace for utilizing crowdsourcing.

Therefore, it would be advantageous to have a method and apparatus that takes into account at least some of the issues discussed above, as well as possibly other issues.

### SUMMARY

According to one embodiment of the present invention, a pricing module prices tasks by receiving a request comprising a task and a description of the task and then identifying the type of task based on the description. The pricing module then retrieves a condition in a marketplace associated with the type and selects a strategy for pricing based on a rule for the type. The module then generates a price for the task using the strategy and adjusts the price based on the condition. The pricing module may also consider a goal for the pricing.

### BRIEF DESCRIPTION OF THE SEVERAL VIEWS OF THE DRAWINGS

FIG. 1 is a pictorial representation of a network of data processing systems in accordance with an illustrative embodiment;

FIG. 2 is an illustration of a block diagram of a system for automated task pricing in a crowdsourcing market depicted in accordance with an illustrative embodiment;

FIG. 3 is an illustration of a block diagram of an overview for a system to automatically price task requests to a crowdsourcing marketplace in accordance with an illustrative embodiment;

FIG. 4 is an illustration of a flowchart of a request pricing process in accordance with an illustrative embodiment;

FIG. 5 is an illustration of a flowchart of a process to select a pricing history pricing strategy in accordance with an illustrative embodiment;

FIG. 6 is an illustration of a flowchart of a process to select a price boundary pricing strategy in accordance with an illustrative embodiment;

FIG. 7 is an illustration of a flowchart of a process to select a valuation and time to apply pricing strategy in accordance with an illustrative embodiment;

FIG. 8 is an illustration of a flowchart of a process to select a complete by a deadline pricing strategy in accordance with an illustrative embodiment;

FIG. 9 is an illustration of a flowchart of a process to select a derivative following pricing strategy in accordance with an illustrative embodiment;

FIG. 10 is an illustration of a flowchart of a process to identify a task type in accordance with an illustrative embodiment;

FIG. 11 is an illustration of a flowchart of a process to select a price bundling pricing strategy in accordance with an illustrative embodiment; and

FIG. 12 is an illustration of a data processing system in accordance with an illustrative embodiment.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

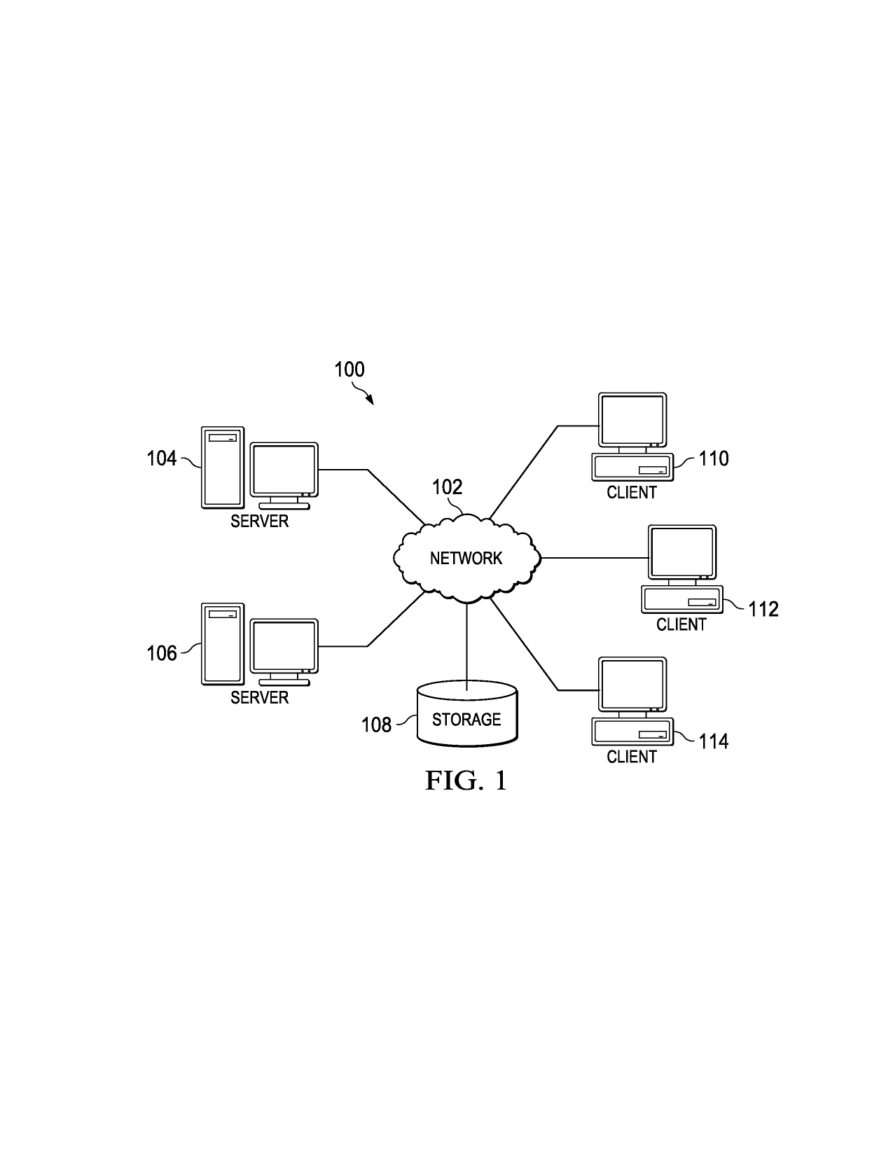

With reference now to the figures and, in particular, with reference to FIG. 1, an illustrative diagram of a data processing environment is provided in which illustrative embodiments may be implemented. It should be appreciated that FIG. 1 is only provided as an illustration of one implementation and is not intended to imply any limitation with regard to the environments in which different embodiments may be implemented. Many modifications to the depicted environments may be made.

FIG. 1 is a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server computer 104 and server computer 106 connect to network 102 along with storage unit 108. In addition, client computers 110, 112, and 114 connect to network 102. Client computers 110, 112, and 114 may be, for example, personal computers or network computers. In the depicted example, server computer 104 provides information, such as boot files, operating system images, and applications to client computers 110, 112, and 114. Client computers 110, 112, and 114 are clients to server computer 104 in this example. Network data processing system 100 may include additional server computers, client computers, and other devices not shown.

Program code located in network data processing system 100 may be stored on a computer-recordable storage medium and downloaded to a data processing system or other device for use. For example, program code may be stored on a computer-recordable storage medium on server computer 104 and downloaded to client computer 110 over network 102 for use on client computer 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers consisting of thousands of commercial, governmental, educational and other computer systems that route data and messages. Of course, network data processing system 100 also may be implemented as a number of different types of networks, such as, for example, an intranet, a local area network (LAN), or a wide area network (WAN). FIG. 1 is intended as an example, and not as an architectural limitation for the different illustrative embodiments.

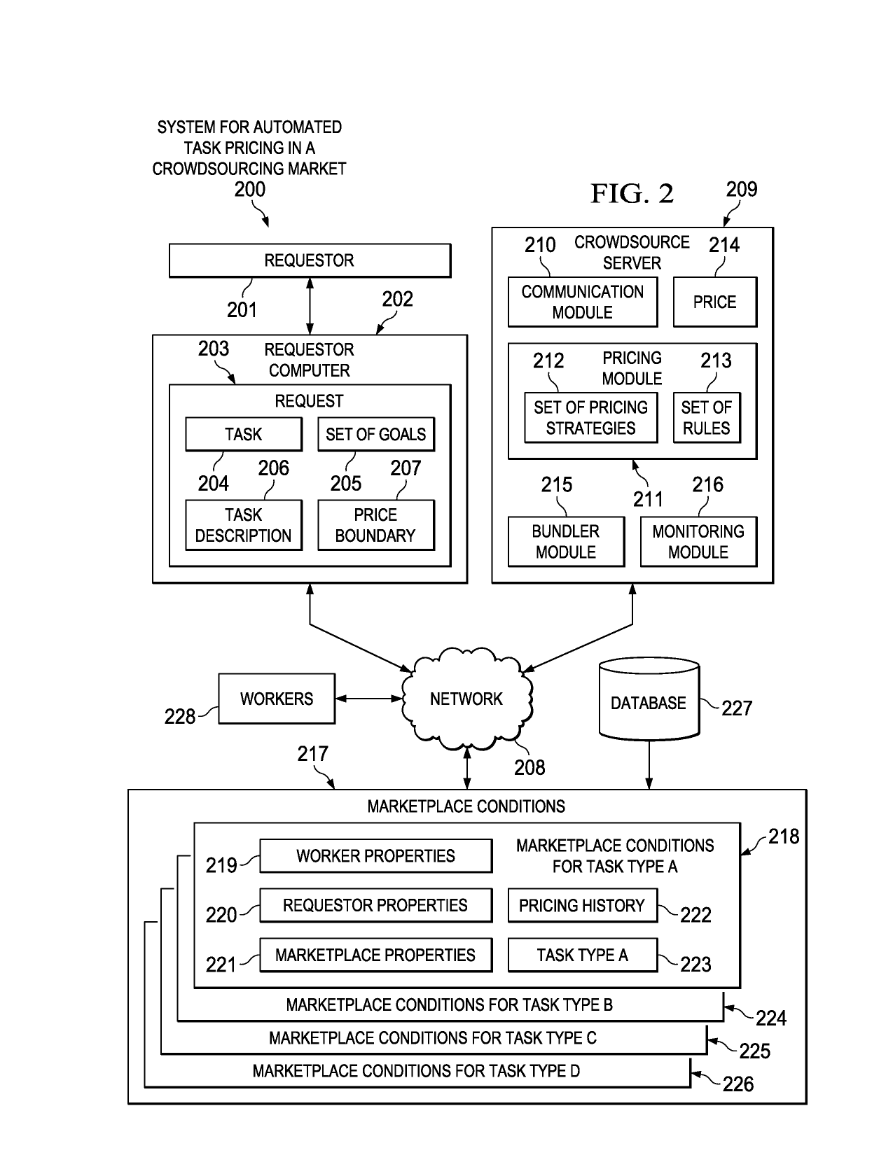

Now with reference to FIG. 2, an illustration of a block diagram of a system for automated task pricing in a crowdsourcing market is depicted in accordance with an illustrative embodiment. It should be appreciated that FIG. 2 is only provided as an illustration of one implementation and is not intended to imply any limitation with regard to the system in which different embodiments may be implemented. Many modifications to the depicted system may be made.

In this illustrative example, system for automated task pricing in a crowdsourcing market 200 depicts requestor 201 interacting with requestor computer 202. As depicted, requestor 201 prepares a request 203 to submit for crowdsourcing. In these illustrative examples, request 203 includes task 204, set of goals 205, task description 206, and price boundary 207. In these illustrative examples, request 203 can be formatted and submitted using a software product providing a data entry interface, a form accessed on an internet website, or a generic form submitted to a website or by fax, or any other readily available method for communicating request 203. As depicted in this example, requestor 201 prepares request 203 on requestor computer 202 for submission using requestor computer 202. Task 204 is the actual task requestor 201 wants to broadcast and crowdsource using network 208. Set of goals 205 specifies at least one goal by requestor 201 for task 204 that may affect pricing. As used herein “set of” means one or more. For example, one of set of goals 205 may specify completing task 204 by a deadline, use a lowest fair price, target a specified group, limit to a specified market, such as by geography, demographic, or industry, or other designated goals. As depicted, task description 206 provides a basic description of the task, such as, for example, provide a business solution for a specified problem in e-commerce or design a green retail package for a new product. As depicted, price boundary 207 can set a budget by requestor 201, such as, for example, a lowest fair price, a maximum price, or a desired price.

In these illustrative examples, requestor computer 202 transmits request 203 using network 208 to crowdsource server 209. Communication module 210 processes all communication between crowdsource server 209 and network 208, receiving and processing request 203 and any other data. As depicted, communication module 210 routes request 203 to pricing module 211, which processes request 203. Pricing module 211, as depicted, also includes set of pricing strategies 212 and pricing rules 213. In these illustrative examples, pricing module 211 generates price 214. However, in these illustrative examples, bundler module 215 can bundle multiple ones of request 203 to also generate price 214. As depicted, depending on request 203, communication module 210 can route several of request 203 to bundler module 215 to generate price 214. In some illustrative embodiments, bundler module 215 can bundle several requests 203 after price 214 is generated, adjusting price 214 according to a bundling pricing strategy. As depicted, monitoring module 216 monitors marketplace conditions 217, which in these illustrative examples, are used by pricing module 211 to generate price 214.

As depicted, marketplace conditions 217 comprise market place properties organized and tracked by task type. In these illustrative examples, marketplace conditions for task type A 218 include worker properties 219, requestor properties 220, marketplace properties 221, pricing history 222, and task type A 223. For example, worker properties 219 can include demographics about different pools of workers, worker data within particular industries, education levels, expertise, number of workers available, location, tasking history, current pricing to workers, participant workers by pricing level, requestor ratings, current task outstanding, and any other relevant data. Requestor properties 220 can include the identity of the requestor, profits and expenses, industry, tasking history, current pricing, worker ratings, and any other relevant data. Marketplace properties 221 can include market ranking, numbers of task, profitability, difficulty of task completion, seasonalability of the market, location of market, market profitability, stability of market, share prices of companies, market expenses, price of materials, price of product, expense of product, and any other relevant data. In these illustrative examples, pricing history 222 tracks historical pricing data for task type A, and type task A 223 specifies the type of task.

As depicted, marketplace conditions 217 includes marketplace conditions for task type A 218, as well as marketplace conditions for task type B 224, marketplace conditions for task type C 225, and marketplace conditions for task type D 226. As depicted, database 227 can store marketplace conditions 217, and monitoring module 216 can both monitor marketplace conditions 217 and update database 227 when properties of marketplace conditions 217 change for each of marketplace conditions for task type A 218, as well as marketplace conditions for task type B 224, marketplace conditions for task type C 225, and marketplace conditions for task type D 226.

As depicted, network 208 also connects to workers 228. Workers 228 receive task 204 and price 214 and can elect to accept task 204 to perform the work or decline task 204.

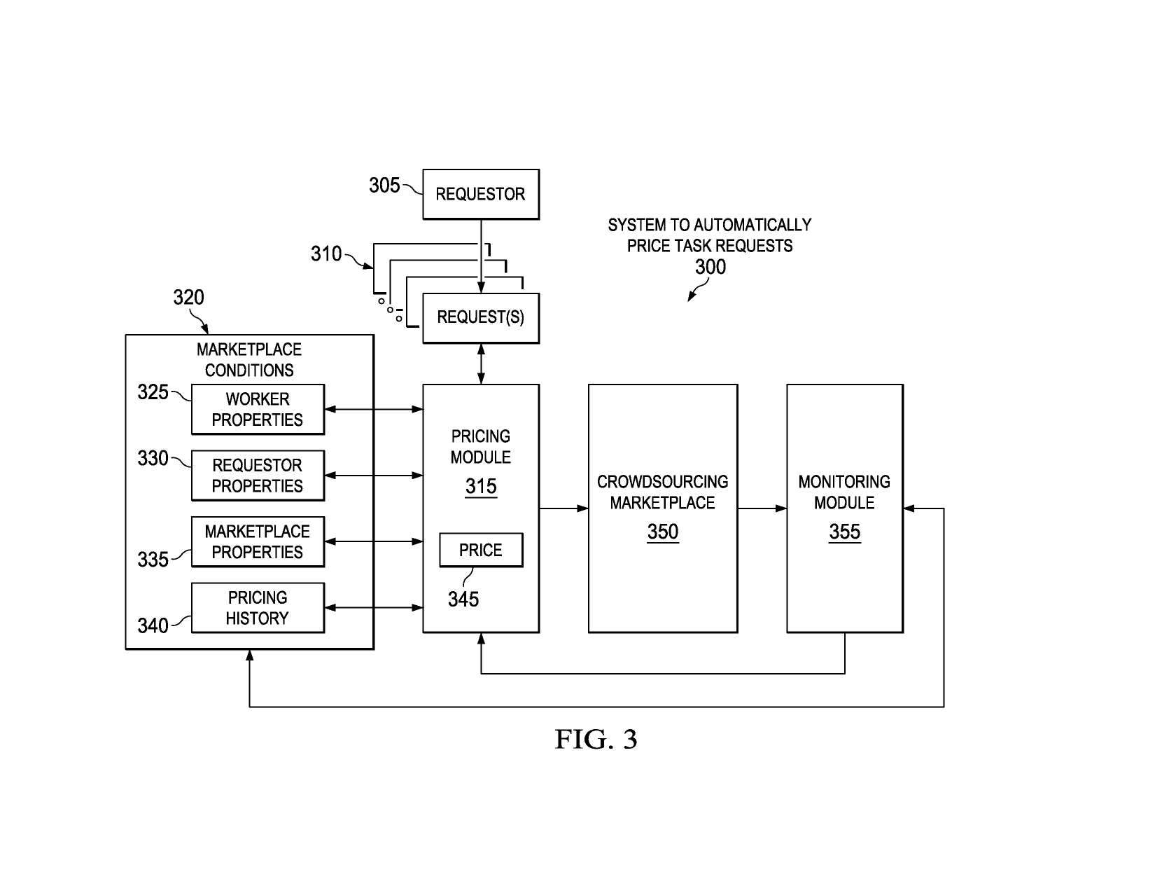

FIG. 3 depicts an illustration of a block diagram of an overview for a system to automatically price task requests to a crowdsourcing marketplace in accordance with an illustrative embodiment. It should be appreciated that FIG. 3 is only provided as an illustration of one implementation and is not intended to imply any limitation with regard to the system in which different embodiments may be implemented. Many modifications to the depicted system may be made.

As depicted, system to automatically price task request 300 shows a requestor 305, who forms request 310, which can include a several individual request 310. Pricing module 315 receives request 310 to process, identifying the type of task. Pricing module 315 retrieves data for marketplace conditions 320 for the type of task. Marketplace conditions 320 comprise worker properties 325, requestor properties 330, marketplace properties 335, and pricing history 340. Pricing module 315 processes the task request utilizing marketplace conditions 320 to generate task price 345, which is transmitted to crowdsourcing marketplace 350. Monitoring component 355 monitors crowdsourcing marketplace 350 to update marketplace conditions 320 and provide feedback to pricing module 315 of changes in marketplace conditions 320. Pricing module 315 dynamically utilizes this data to modify task price 345, updating task price 345 on defined time intervals or upon detection of changes in crowdsourcing marketplace 350, such as, for example, a significant change in the number of requestors or workers or a significant change in worker preferences requiring a re-pricing.

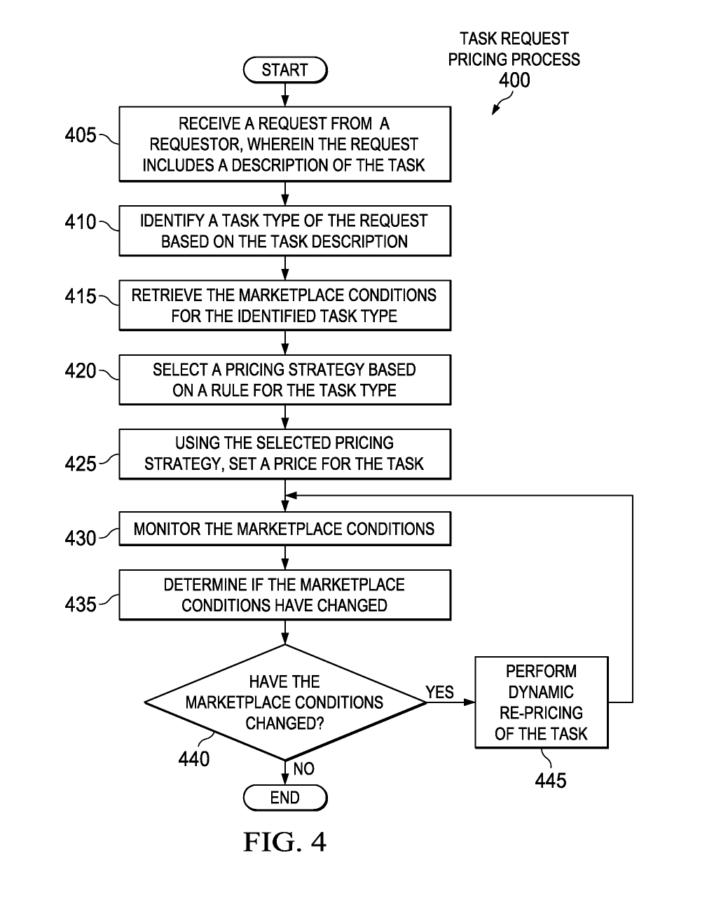

Turning now to FIG. 4, an illustration of a flowchart of a request pricing process is depicted in accordance with an illustrative embodiment. It should be appreciated that FIG. 4 is only provided as an illustration of one implementation and is not intended to imply any limitation with regard to the process in which different embodiments may be implemented. Many modifications to the depicted flowchart may be made.

In these illustrative examples, task request pricing process 400 can be implemented in pricing module 211 of FIG. 2. With further reference to FIG. 2, as depicted, the process begins with pricing module 211 receiving request 203 from requestor 201, wherein request 203 includes a description of task 204, i.e., task description 206 in FIG. 2 (step 405). In these illustrative examples, request 203 can comprise additional elements, such as, for example, task 204, set of goals 205, and price boundary 207. Additionally, in these illustrative examples, set of goals 205 may be selected or described by requestor 201, may be extracted from task description 206, or selected based on task description 206. As depicted, pricing module 211 then identifies a task type of request 203 based on task description 206 (step 410). After identifying the task type, such as for example task type A 223, as depicted, pricing module 211 retrieves marketplace conditions 217 for the identified task type, such as, for example marketplace conditions for task type A 218. With reference to FIG. 2, as depicted, marketplace conditions 217 are organized by task type, such as for example task type A 223, and comprise worker properties 219, requestor properties 220, marketplace properties 221, and pricing history 222. As depicted, pricing module 211 selects one of set of pricing strategies 212 based on one of rules 213 for the task type, such as a rule from rules 213 for task type A 223 (step 420). In these illustrative examples, both rules 213 and set of pricing strategies 213 can be specified or selected in pricing module 211.

As depicted, pricing module 211 selects one of set of pricing strategies 212 to set price 214 for task 204 (step 425), and the system monitors marketplace conditions 217 (step 430). In these illustrative examples, with reference to FIGS. 2 and 3, monitoring module 355 monitors marketplace conditions 217 and crowdsourcing marketplace 350, to detect changes in both marketplace conditions 217 and crowdsourcing marketplace 350, and update marketplace conditions 217 with detected changes in crowdsourcing marketplace 350. As depicted, pricing module 211 determines if marketplace conditions 217 have changed, either in database 227 or crowdsourcing marketplace 350 (step 435). As depicted, in step 440, if marketplace conditions 217 have changed, pricing module 211 performs dynamic re-pricing of task 204, adjusting price 214 to account for changed marketplace conditions 217 and returning to step 430. For example, pricing module 211 may determine that the pool of relevant workers for task 204 are currently limited in number and sufficient numbers of relevant workers will not respond to task 204 at generated price 214. In these illustrative examples, pricing module 211 dynamically re-prices task 204 to set a higher price 214 accounting for the change in marketplace conditions 217. If marketplace conditions 217 do not change, the process ends.

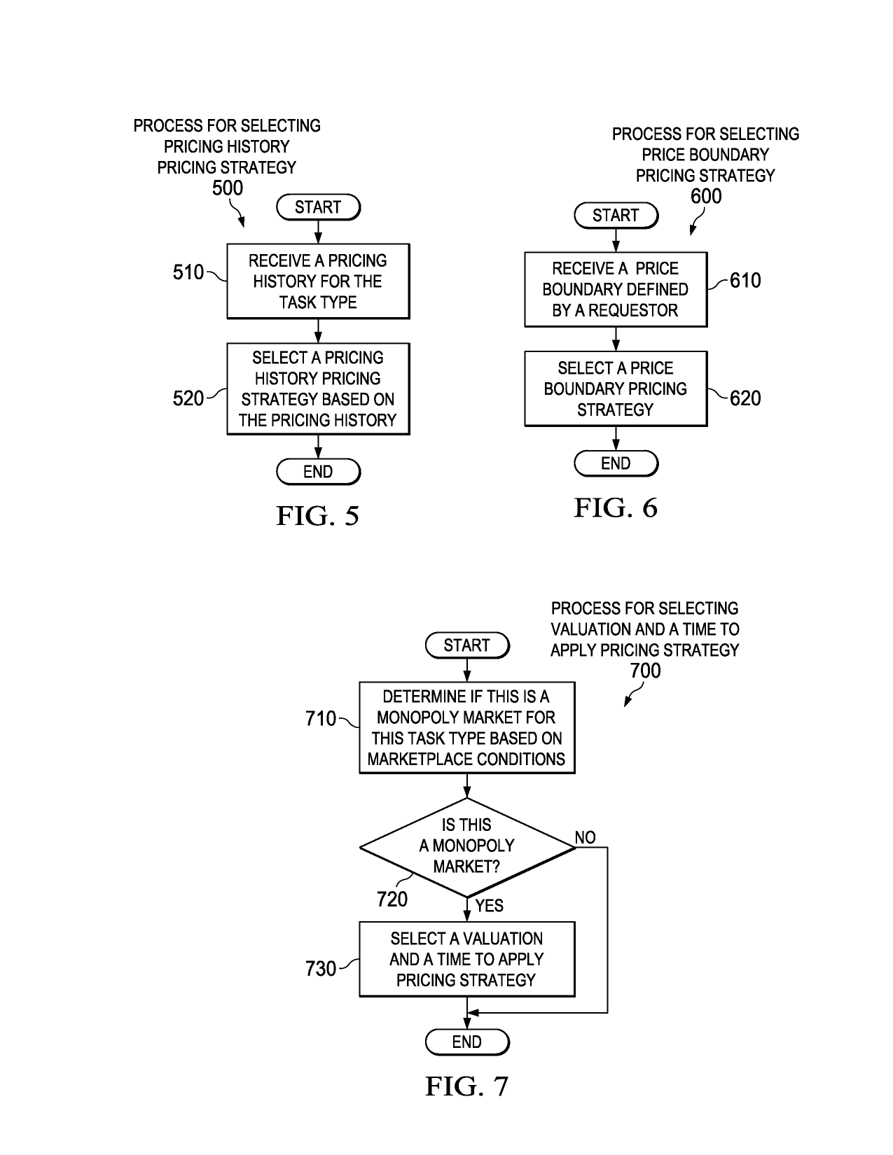

FIG. 5 depicts an illustration of a flowchart of a process to select a pricing history pricing strategy in accordance with an illustrative embodiment. It should be appreciated that FIG. 5 is only provided as an illustration of one implementation and is not intended to imply any limitation with regard to the process in which different embodiments may be implemented. Many modifications to the depicted flowchart may be made.

In these illustrative examples, process for selecting pricing history pricing strategy 500 can be implemented in pricing module 211 of FIG. 2 to select a pricing strategy based on a rule for the task type as depicted at step 420 in FIG. 4. As depicted, the process begins with pricing module 211 receiving a pricing history for the task type, such as, for example pricing history 222 for task type A 223 in FIG. 2 (step 510). As depicted, pricing module 211 selects a pricing history pricing strategy based on pricing history 222 from set of pricing strategies 212. For example, further referring to FIG. 3, when pricing module 315 retrieves system marketplace conditions 320 containing pricing history 340, rules 213 in pricing module 315 cause selecting the pricing history pricing strategy in response.

FIG. 6 depicts an illustration of a flowchart of a process to select a price boundary pricing strategy in accordance with an illustrative embodiment. It should be appreciated that FIG. 6 is only provided as an illustration of one implementation and is not intended to imply any limitation with regard to the process in which different embodiments may be implemented. Many modifications to the depicted flowchart may be made.

In these illustrative examples, process for selecting price boundary pricing strategy 600 can be implemented in pricing module 211 of FIG. 2 to select a pricing strategy based on a rule for the task type as depicted at step 420 in FIG. 4. As depicted, pricing module 211 receives price boundary 207 defined by requestor 201 in FIG. 2 (step 610). As depicted, pricing module 211 then selects a price boundary pricing strategy (step 620) from set of pricing strategies 212, ending the process. For example, with further reference to FIG. 3, when pricing module 315 receives request 310 containing price boundary 207, rules 213 in pricing module 315 cause selecting the price boundary pricing strategy in response.

FIG. 7 depicts an illustration of a flowchart of a process to select a valuation and time to apply pricing strategy in accordance with an illustrative embodiment. It should be appreciated that FIG. 7 is only provided as an illustration of one implementation and is not intended to imply any limitation with regard to the process in which different embodiments may be implemented. Many modifications to the depicted flowchart may be made.

In these illustrative examples, process for selecting valuation and a time to apply pricing strategy 700 can be implemented in pricing module 211 of FIG. 2 to select a pricing strategy based on a rule for the task type as depicted at step 420 in FIG. 4. As depicted, pricing module 211 determines if this is a monopoly market for this task type based on marketplace conditions (step 710). As depicted, if pricing module 211 determines this is a monopoly market (step 720), then pricing module 211 selects a valuation and a time to apply pricing strategy (step 730) from set of pricing strategies 212, ending the process. As depicted, if pricing module 211 determines this is not a monopoly market (step 720), the process ends. For example, referring to FIG. 2 and FIG. 3, when pricing module 315 receives marketplace properties 335 for task 204, pricing module 315 determines marketplace properties 335 indicate a monopoly. Rules 213 in pricing module 315 cause selecting the valuation and a time to apply pricing strategy in response.

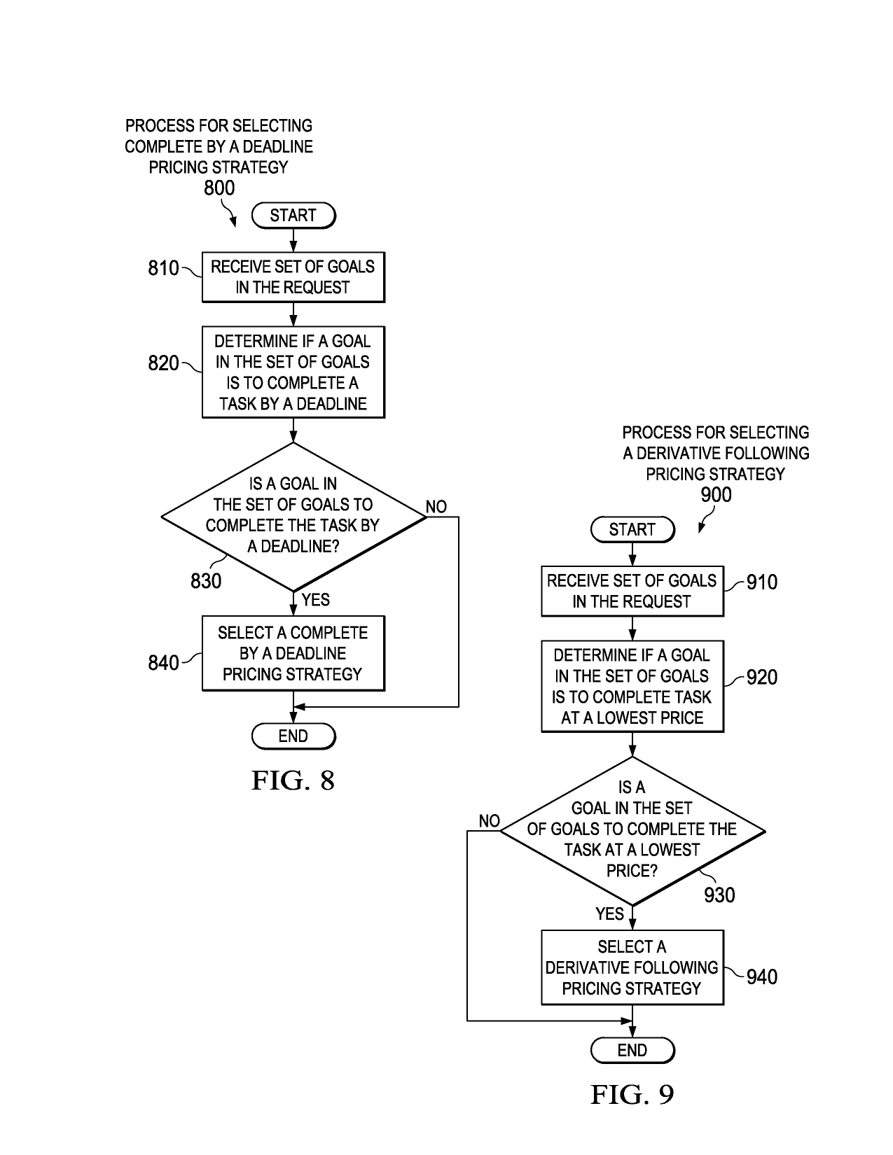

Now turning to FIG. 8, an illustration of a flowchart of a process to select a complete by a deadline pricing strategy in accordance with an illustrative embodiment is depicted. It should be appreciated that FIG. 8 is only provided as an illustration of one implementation and is not intended to imply any limitation with regard to the process in which different embodiments may be implemented. Many modifications to the depicted flowchart may be made.

In these illustrative examples, process for selecting complete by a deadline pricing strategy 800 can be implemented in pricing module 211 of FIG. 2 to select a pricing strategy based on a rule for the task type as depicted at step 420 in FIG. 4. As depicted, and referring to FIG. 2, the process begins with pricing module 211 receiving set of goals 205 in request 203 (step 810). As depicted, pricing module 211 determines if a goal in set of goals 205 is to complete task 204 by a deadline (step 820). As depicted, if a goal in set of goals 205 is to complete task 204 by a deadline (step 830), pricing module 211 then selects a complete by a deadline pricing strategy (step 840) from set of pricing strategies 212, and then ends. If a goal in set of goals 205 is not to complete task 204 by a deadline at step 830, as depicted the process ends.

Now turning to FIG. 9, an illustration of a flowchart of a process to select a derivative following pricing strategy in accordance with an illustrative embodiment is depicted. It should be appreciated that FIG. 9 is only provided as an illustration of one implementation and is not intended to imply any limitation with regard to the process in which different embodiments may be implemented. Many modifications to the depicted flowchart may be made.

In these illustrative examples, process for selecting a derivative following pricing strategy 900 can be implemented in pricing module 211 of FIG. 2 to select a pricing strategy based on a rule for the task type as depicted at step 420 in FIG. 4. As depicted, and referring to FIG. 2, the process begins with pricing module 211 receiving a set of goals 205 in request 203 (step 910). As depicted in step 920, pricing module 211 determines if a goal in the set of goals 205 is to complete task 204 at a lowest fair price. As depicted, if a goal in the set of goals 205 is to complete task 204 at a lowest fair price (step 930), then pricing module 211 selects a derivative following pricing strategy (step 940) from set of pricing strategies 212, and then ends. If a goal in the set of goals 205 is not to complete task 204 at a lowest fair price at step 930, as depicted the process ends.

More generically, other goal directed strategies may be implemented beyond these illustrative examples. Many goals may be designated in set of goals 205, and implemented as depicted in FIGS. 8 and 9. Moreover, in these illustrative examples, these figures may be interchanged, with different priorities for selecting one pricing strategy from set of pricing strategies 212 based on set of rules 213 and set of goals 205.

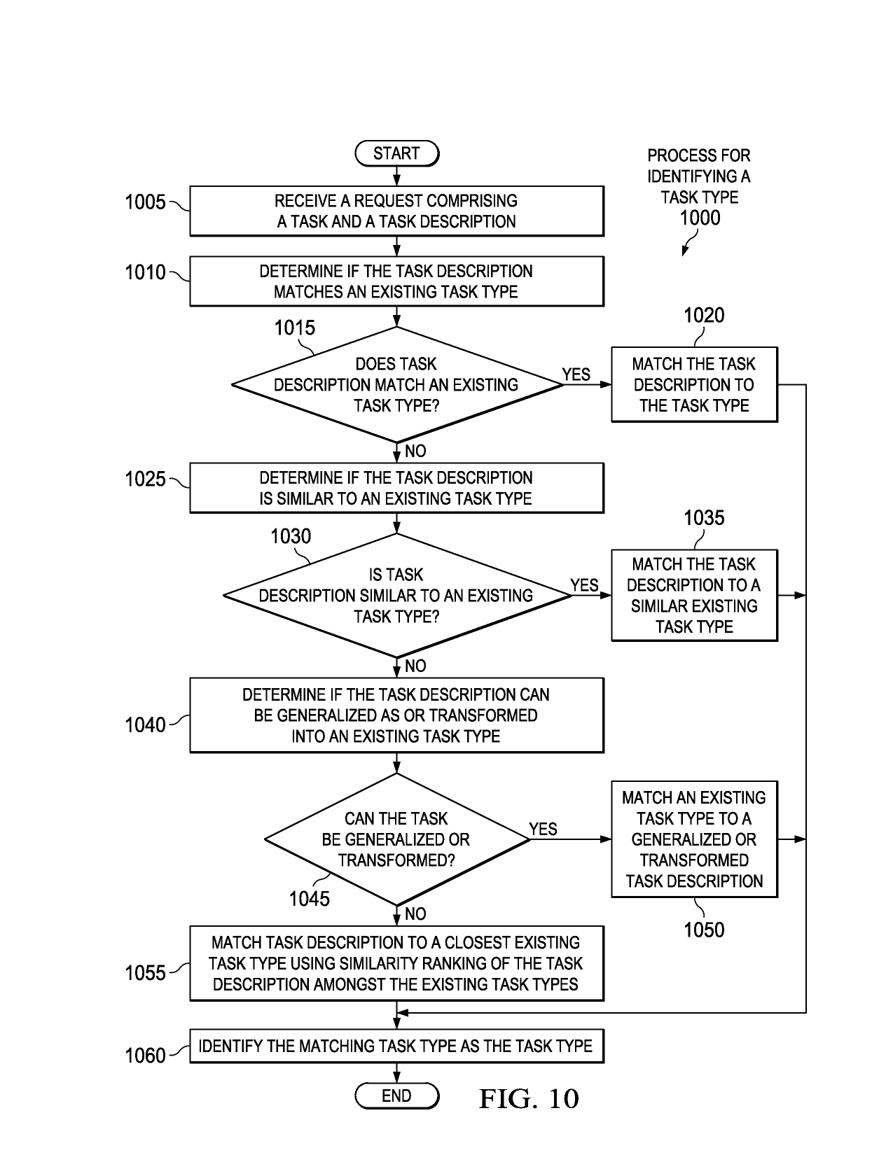

In FIG. 10, an illustration of a flowchart of a process to identify a task type in accordance with an illustrative embodiment is depicted. It should be appreciated that FIG. 10 is only provided as an illustration of one implementation and is not intended to imply any limitation with regard to the process in which different embodiments may be implemented. Many modifications to the depicted flowchart may be made.

In these illustrative examples, process for identifying a task type 1000 in an example embodiment for step 410 of FIG. 4 can be implemented by pricing module 211 as depicted in FIG. 2. As depicted, and referring to FIG. 2, pricing module 211 receives request 203 comprising task 204 and task description 206 (step 1005). As depicted, pricing module 211 next determines if task description 206 matches an existing task type, such as for example task type A 223 (step 1010). Next, as depicted, if task description 206 matches an existing task type, the process proceeds to step 1020 (step 1015). As depicted, pricing module 211 matches task description 206 to, for example, task type A 223 (step 1020). As depicted, if task description 206 does not match an existing task type, then pricing module 211 determines if task description 206 is similar to an existing task type, such as for example task type A 223 (step 1025). As depicted, if task description 206 is similar to an existing task type (step 1030), such as for example task type A 223, then pricing module 211 matches task description 206 to a similar task type, such as task type A 223 for example (step 1035).

If task description 206 is not similar to an existing task type (step 1030), as depicted in step 1040, pricing module 211 determines if task description 206 can be generalized or transformed into an existing task type, such as for example task type A 223. As depicted, if task description 206 can be generalized or transformed (step 1045), pricing module 211 matches an existing task type, such as for example task type A 223, to a generalized or transformed task description 206 (step 1050). As depicted, if task description 206 can not be generalized or transformed into an existing task type (step 1045), pricing module 211 matches task description 206 to a closest existing task type using similarity ranking of task description 206 amongst the existing task types, such as for example matching to task type A 223 from amongst task type A 223, task type B 224, task type C 225, and task type D 226 (step 1055). As depicted, proceeding from steps 1020, 1035, 1050, and 1055, pricing module 211 identifies matching task type A 223 as the task type (step 1060).

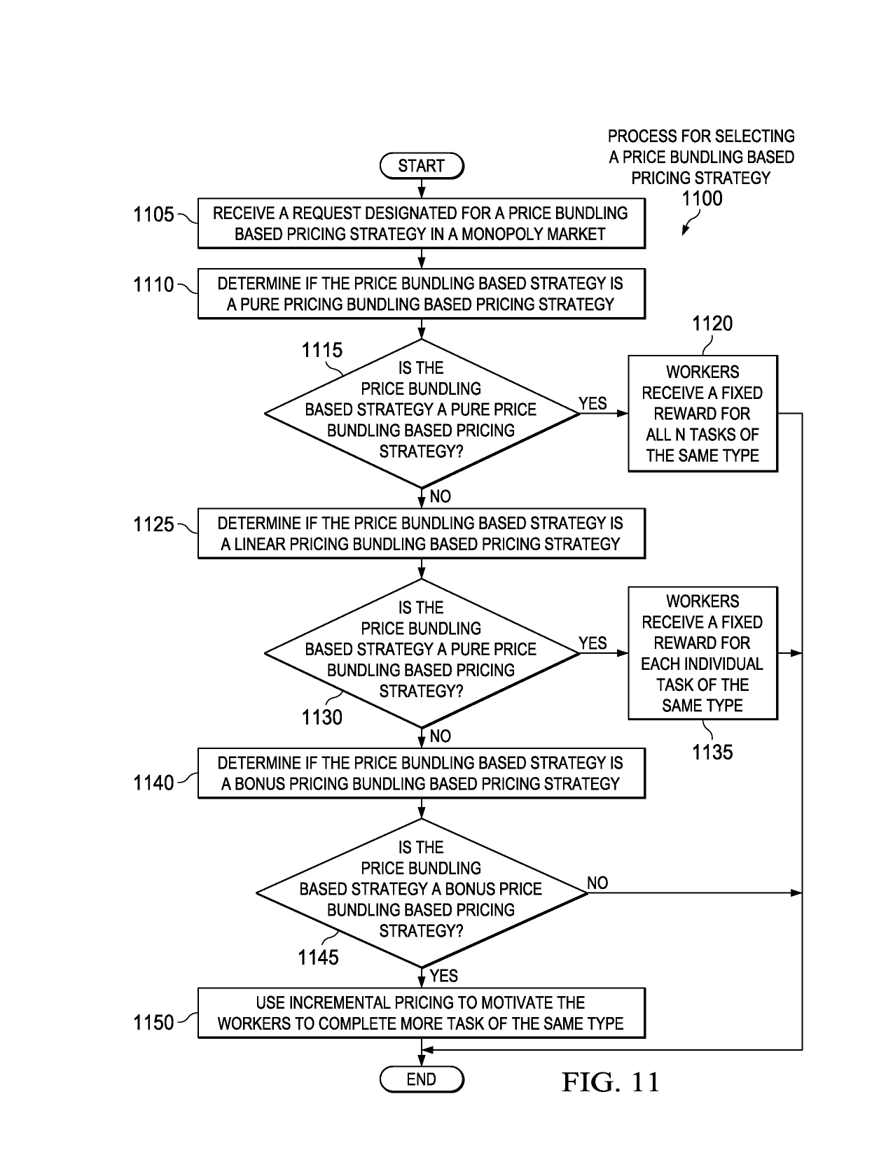

FIG. 11 depicts an illustration of a flowchart of a process to select a price bundling pricing strategy type in accordance with an illustrative embodiment. It should be appreciated that FIG. 11 is only provided as an illustration of one implementation and is not intended to imply any limitation with regard to the process in which different embodiments may be implemented. Many modifications to the depicted flowchart may be made.

In these illustrative examples, process for selecting a price bundling based pricing strategy 1100 can be implemented in bundler module 215 of FIG. 2 to select a pricing strategy based on price bundling. As depicted with reference to FIG. 2, the process begins with bundler module 215 receiving request 203 designated for a price bundling based pricing strategy in a monopoly market (step 1105). As depicted, bundler module 215 determines if the price bundling based strategy is a pure pricing bundling based pricing strategy (step 1110). As depicted, if the price bundling based strategy is a pure pricing bundling based pricing strategy, then workers receive a fixed reward for all N tasks of the same type (step 1120) with price 214 generated accordingly by bundler module 215. For example, and referring to FIG. 2, a pure pricing bundling based strategy can set price 214 equal to, for example, $20.00 for completing twenty-five task 204 of task type A 233, with each completed twenty-five of task 204 of task type A 233 earning a worker $20.00.

As depicted, if the price bundling based strategy is not a pure pricing bundling based pricing strategy (step 1115), bundler module 215 determines if the price bundling based strategy is a linear pricing bundling based pricing strategy (step 1125). As depicted, if the price bundling based strategy is a linear pricing bundling based pricing strategy (step 1130), then workers receive a fixed reward for each individual task of the same type (step 1135) with price 214 generated accordingly by bundler module 215. For example, and referring to FIG. 2, a linear pricing bundling based pricing strategy can set price 214 equal to, for example, $20.00 for completing each task 204 of task type A 233, with each completed task 204 of task type A 233 earning a worker $20.00.

As depicted, if the price bundling based strategy is not a linear pricing bundling based pricing strategy (step 1130), bundler module 211 determines if the price bundling based strategy is a bonus pricing bundling based pricing strategy (step 1140). As depicted, if the price bundling based strategy is a bonus pricing bundling based pricing strategy, then bundler module 215 uses incremental pricing to motivate the workers to complete tasks of the same type more efficiently (step 1150) with price 214 generated accordingly by bundler module 215. For example, and referring to FIG. 2, a incremental pricing bundling based pricing strategy can set price 214 equal to, for example, $20.00 for completing fifteen of task 204 of task type A 233, then for completing the next fifteen of task 204 of task type A 233, the price 214 can equal $25.00, earning a worker a total of $45.00 for completing thirty of task 204. As depicted, if the price bundling based strategy is not a bonus pricing bundling based pricing strategy, then the process ends (step 1150). From steps 1120, 1135, and 1150, the process also ends.

Although depicted as a separate component, it is readily apparent bundler module 215 can be incorporated into pricing module 211. That is, pricing module 211 can be configured to bundle multiple tasks as described, or bundler module 215 can be a software module operating within pricing module 211. Pricing module 211 and bundler module 215 can be implemented in numerous ways, as can crowdsource server 209.

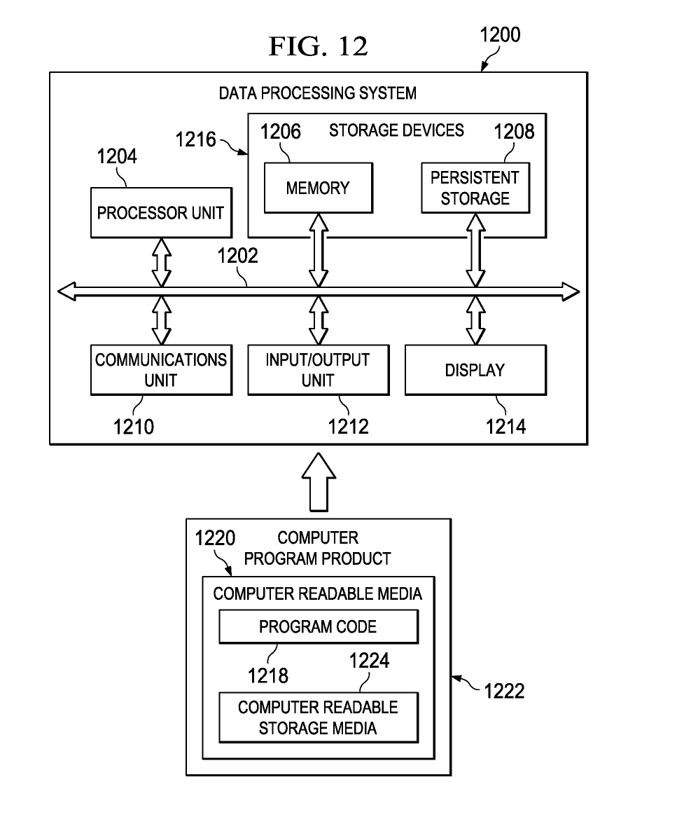

FIG. 12 is an illustration of a block diagram of a data processing system in accordance with an illustrative embodiment. It should be appreciated that FIG. 12 is only provided as an illustration of one implementation and is not intended to imply any limitation with regard to the process in which different embodiments may be implemented. Many modifications to the depicted flowchart may be made.

In this illustrative example, data processing system 1200 includes communications fabric 1202, which provides communications between processor unit 1204, memory 1206, persistent storage 1208, communications unit 1210, input/output (I/O) unit 1212, and display 1214.

Processor unit 1204 serves to execute instructions for software that may be loaded into memory 1206. Processor unit 1204 may be a number of processors, a multi-processor core, or some other type of processor, depending on the particular implementation. A number, as used herein with reference to an item, means one or more items. Further, processor unit 1204 may be implemented using a number of heterogeneous processor systems in which a main processor is present with secondary processors on a single chip. As another illustrative example, processor unit 1204 may be a symmetric multi-processor system containing multiple processors of the same type.

Memory 1206 and persistent storage 1208 are examples of storage devices 1216. A storage device is any piece of hardware that is capable of storing information, such as, for example, without limitation, data, program code in functional form, and/or other suitable information either on a temporary basis and/or a permanent basis. Storage devices 1216 may also be referred to as computer-readable storage devices in these examples. Memory 1206, in these examples, may be, for example, a random access memory or any other suitable volatile or non-volatile storage device. Persistent storage 1208 may take various forms, depending on the particular implementation.

For example, persistent storage 1208 may contain one or more components or devices. For example, persistent storage 1208 may be a hard drive, a flash memory, a rewritable optical disk, a rewritable magnetic tape, or some combination of the above. The media used by persistent storage 1208 also may be removable. For example, a removable hard drive may be used for persistent storage 1208.

Communications unit 1210, in these examples, provides for communications with other data processing systems or devices. In these examples, communications unit 1210 is a network interface card. Communications unit 1210 may provide communications through the use of either or both physical and wireless communications links.

Input/output unit 1212 allows for input and output of data with other devices that may be connected to data processing system 1200. For example, input/output unit 1212 may provide a connection for user input through a keyboard, a mouse, and/or some other suitable input device. Further, input/output unit 1212 may send output to a printer. Display 1214 provides a mechanism to display information to a user.

Instructions for the operating system, applications, and/or programs may be located in storage devices 1216, which are in communication with processor unit 1204 through communications fabric 1202. In these illustrative examples, the instructions are in a functional form on persistent storage 1208. These instructions may be loaded into memory 1206 for execution by processor unit 1204. The processes of the different embodiments may be performed by processor unit 1204 using computer implemented instructions, which may be located in a memory, such as memory 1206.

These instructions are referred to as program code, computer-usable program code, or computer-readable program code that may be read and executed by a processor in processor unit 1204. The program code in the different embodiments may be embodied on different physical or computer-readable storage media, such as memory 1206 or persistent storage 1208.

Program code 1218 is located in a functional form on computer-readable media 1220 that is selectively removable and may be loaded onto or transferred to data processing system 1200 for execution by processor unit 1204. Program code 1218 and computer-readable media 1220 form computer program product 1222 in these examples. In one example, computer-readable media 1220 may be computer-readable storage media 1224. Computer-readable storage media 1224 may include, for example, an optical or magnetic disk that is inserted or placed into a drive or other device that is part of persistent storage 1208 for transfer onto a storage device, such as a hard drive, that is part of persistent storage 1208. Computer-readable storage media 1224 also may take the form of a persistent storage, such as a hard drive, a thumb drive, or a flash memory, that is connected to data processing system 1200. In some instances, computer-readable storage media 1224 may not be removable from data processing system 1200.

The different components illustrated for data processing system 1200 are not meant to provide architectural limitations to the manner in which different embodiments may be implemented. The different illustrative embodiments may be implemented in a data processing system including components in addition to or in place of those illustrated for data processing system 1200. Other components shown in FIG. 12 can be varied from the illustrative examples shown. The different embodiments may be implemented using any hardware device or system capable of running program code. As one example, the data processing system may include organic components integrated with inorganic components and/or may be comprised entirely of organic components excluding a human being. For example, a storage device may be comprised of an organic semiconductor.

In another illustrative example, processor unit 1204 may take the form of a hardware unit that has circuits that are manufactured or configured for a particular use. This type of hardware may perform operations without needing program code to be loaded into a memory from a storage device to be configured to perform the operations.

For example, when processor unit 1204 takes the form of a hardware unit, processor unit 1204 may be a circuit system, an application specific integrated circuit (ASIC), a programmable logic device, or some other suitable type of hardware configured to perform a number of operations. With a programmable logic device, the device is configured to perform the number of operations. The device may be reconfigured at a later time or may be permanently configured to perform the number of operations. Examples of programmable logic devices include, for example, a programmable logic array, programmable array logic, a field programmable logic array, a field programmable gate array, and other suitable hardware devices. With this type of implementation, program code 1218 may be omitted because the processes for the different embodiments are implemented in a hardware unit.

In still another illustrative example, processor unit 1204 may be implemented using a combination of processors found in computers and hardware units. Processor unit 1204 may have a number of hardware units and a number of processors that are configured to run program code 1218. With this depicted example, some of the processes may be implemented in the number of hardware units, while other processes may be implemented in the number of processors.

As another example, a storage device in data processing system 1200 is any hardware apparatus that may store data. Memory 1206, persistent storage 1208, and computer-readable media 1220 are examples of storage devices in a tangible form.

In another example, a bus system may be used to implement communications fabric 1202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 1206, or a cache, such as found in an interface and memory controller hub that may be present in communications fabric 1202.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A computer implemented method for pricing tasks comprising:
receiving, by a processor, a request comprising a task and a description of the task;
identifying, by the processor, the type of task based on the description;
retrieving, by the processor, a condition in a marketplace associated with the type, wherein the condition comprises worker properties, wherein the worker properties are selected from a list consisting of: demographics about different pools of workers, worker data within particular industries, education levels, an expertise, workers available, a location, a tasking history, current pricing to workers, participant workers by pricing level, requestor ratings, and a current task outstanding;
selecting, by the processor, a strategy for pricing based on a rule for the type;
generating, by the processor, a price for the task using the strategy;
monitoring, by the processor, the condition;
determining, by the processor, the condition changed to require adjusting the price, wherein the condition is a pre-determined number of relevant workers responding to the task at the price, and the change in the condition is less than the pre-determined number of relevant workers responding to the task at the price; and
adjusting the price based on the change in the condition.

2. (canceled)

3. The method of claim 1, wherein identifying the type of task comprises:
determining, by the processor, the description of the task matches an existing type of task; and
identifying, by the processor, the task as belonging to the existing type of task that matches.

4. The method of claim 1, wherein identifying the type of task comprises:
determining, by the processor, the description of the task does not match an existing type of task; then, determining, by the processor:
if the description is similar to an existing type, then identifying, by the processor, the existing type of task that is similar as belonging to the type of the task, or
if the description can be generalized or transformed into an existing type, then generalizing or transforming, by the processor, the description to match the existing type, then identifying, by the processor, the existing type matched to the description as belonging to the type of the task, or
if the description is not similar to an existing type nor can be generalized or transformed into an existing type, then using similarity ranking of the description, by the processor, amongst a group of existing types to match to a closest existing type, then identifying, by the processor, the closest existing type matched to the description as belonging to the type of the task.

5. The method of claim 1, wherein the strategy comprises:
a pricing history strategy;
a price boundary strategy;
a valuation and time to apply strategy in a monopoly market;
a goal directed strategy; and
a derivative following strategy.

6. The method of claim 1, wherein the rule is selected based on the condition.

7. The method of claim 1, wherein the condition comprises:
requestor properties;
marketplace properties; and
pricing history.

8. The method of claim 1, further comprising:
receiving, by the processor, a request comprising a task designated for a bundling strategy; and
using, by the processor, the bundling strategy to generate the price.

9. The method of claim 8, further comprising bundling, by the processor, multiple tasks and offering multiple bundle options to a requestor at different pricing according to the bundling strategy.

10. The method of claim 8, wherein the bundling strategy comprises:
a pure bundling strategy, with a set of workers receiving a fixed reward for all task of a same type;
a linear bundling strategy, with a set of workers receiving a fixed reward for each task of the same type; and
a bonus bundling strategy, with a set of workers receiving incremental rewards to motivate completion of tasks more efficiently of the same type.

11. The method of claim 1, further comprising:
monitoring, by the processor, the marketplace to update the condition.

12. A computer program product for pricing tasks, the computer program product comprising:
a non-transitory computer readable storage medium;
program code, stored on the non-transitory computer readable storage medium, for receiving a request comprising a task and a description of the task;
program code, stored on the non-transitory computer readable storage medium, for identifying the type of task based on the description;
program code, stored on the non-transitory computer readable storage medium, for retrieving a condition in a marketplace associated with the type, wherein the condition comprises worker properties, wherein the worker properties are selected from a list consisting of: demographics about different pools of workers, worker data within particular industries, education levels, an expertise, workers available, a location, a tasking history, current pricing to workers, participant workers by pricing level, requestor ratings, and a current task outstanding;
program code, stored on the non-transitory computer readable storage medium, for selecting a strategy based on a rule for the type;
program code, stored on the non-transitory computer readable storage medium, for generating a price for the task using the strategy;
program code, stored on the non-transitory computer readable storage medium, for monitoring, by the processor, the condition;
program code, stored on the non-transitory computer readable storage medium, for determining, by the processor, the condition changed to require adjusting the price, wherein the condition is that a predetermined number of relevant workers respond to the task at the price, and the change in the condition is that less than the predetermined number of relevant workers respond to the task at the price; and
program code, stored on the non-transitory computer readable storage medium, for adjusting the price based on the condition.

13. The computer program product of claim 12, further comprising:
program code, stored on the non-transitory computer readable storage medium, for monitoring the condition; and
program code, stored on the non-transitory computer readable storage medium, for determining the condition changed to require adjusting the price.

14. The computer program product of claim 12, wherein identifying the type of task comprises:
program code, stored on the non-transitory computer readable storage medium, for determining the description of the task matches an existing type of task; and
program code, stored on the non-transitory computer readable storage medium, for identifying the task as belonging to the existing type of task that matches.

15. The computer program product of claim 12, wherein identifying the type of task comprises:
program code, stored on the non-transitory computer readable storage medium, for determining the description of the task does not match an existing type of task; then, determining, by the processor,
if the description is similar to an existing type, program code, stored on the computer readable storage medium, for then identifying the existing type of task that is similar as belonging to the type of the task, or
if the description can be generalized or transformed into an existing type, program code, stored on the computer readable storage medium, for then -generalizing or transforming the description to match the existing type, then identifying the existing type matched to the description as belonging to the type of the task, or
if the description is not similar to an existing type nor can be generalized or transformed into an existing type, program code, stored on the computer readable storage medium, for then using similarity ranking of the description amongst a group of existing types to match to a closest existing type, then identifying the closest existing type matched to the description as belonging to the type of the task.

16. The computer program product of claim 12, wherein the condition comprises:
requestor properties;
marketplace properties; and
pricing history.

17. A data processing system for pricing tasks, the system comprising:
a bus system;
a storage device connected to the bus system, wherein the storage device includes program code;
a processor unit configured to execute the program code to receive a request comprising a task and a description of the task; identify the type of task based on the description; retrieve a condition in a marketplace associated with the type, wherein the condition comprises worker properties, wherein the worker properties are selected from a list consisting of: demographics about different pools of workers, worker data within particular industries, education levels, an expertise, workers available, a location, a tasking history, current pricing to workers, participant workers by pricing level, requestor ratings, and a current task outstanding, select a strategy based on a rule for the type; generate a price for the task using the strategy, monitor the condition;
determine the condition changed to require adjusting the price, wherein the condition is that a predetermined number of relevant workers respond to the task at the price, and the change in the condition is that less than the pre-determined number of relevant workers respond to the task at the price; and adjust the price based on the change in the condition.

18. The data processing system of claim 17, further comprising:
the processing unit configured to monitor the condition; and
the processing unit configured to determine the condition changed to require adjusting the price.

19. The data processing unit of claim 17, wherein identifying the type of task comprises:
the processing unit configured to determine the description of the task matches an existing type of task; and
the processing unit configured to identify the task as belonging to the existing type of task that matches.

20. The data processing unit of claim 17, wherein identifying the type of task comprises:
the processing unit configured to determine the description of the task does not match an existing type of task; then, determining, by the processor unit,
if the description is similar to an existing type, then identifying the existing type of task that is similar as belonging to the type of the task, or
if the description can be generalized or transformed into an existing type, then generalizing or transforming the description to match the existing type, then identifying the existing type matched to the description as belonging to the type of the task, or
if the description is not similar to an existing type nor can be generalized or transformed into an existing type then using similarity ranking of the description amongst a group of existing types to match to a closest existing type, then identifying the closest existing type matched to the description as belonging to the type of the task.
